(19) United States
(12) Patent Application Publication
(10) Pub. No.: US 2006/0137240 A1
(43) Pub. Date: Jun. 29, 2006

(54) Funnel 3 in 1 insect trap

(76) Inventor: Jerry Wayne Dismore, Villa Park, IL (US)

Correspondence Address: JERRY W. DISMORE, 1121 N. PRINCETON, VILLA PARK., IL, 60181, US

(21) Appl. No.: 10/971,246

(22) Filed: Dec. 28, 2004

(51) Int. Cl. A01M 1/10

(52) U.S. Cl. 43/107; 43/65

(57) ABSTRACT

The 2.5″ long funnel is built for catching and trapping flies, yellow jackets, ants and other flying/crawling insects that are attracted to the smell in the plastic jar. Insects crawl down the funnel into the jar and can't get back out. Insects fly/crawl around inside the jar until they are exhausted and fall into the liquid, causing them to drown. The funnel is made of ridged wire screen and is permanently attached under the screw on cap. There is no need to go and buy one insect trap for files, one for yellow jackets and one for ants; when all you need is “The Funnel 3 in 1 Insect Trap”. Tested for 2 years from models made at my home. Works great!

Detailed description of the preferred embodiment now referring to the drawing in detail

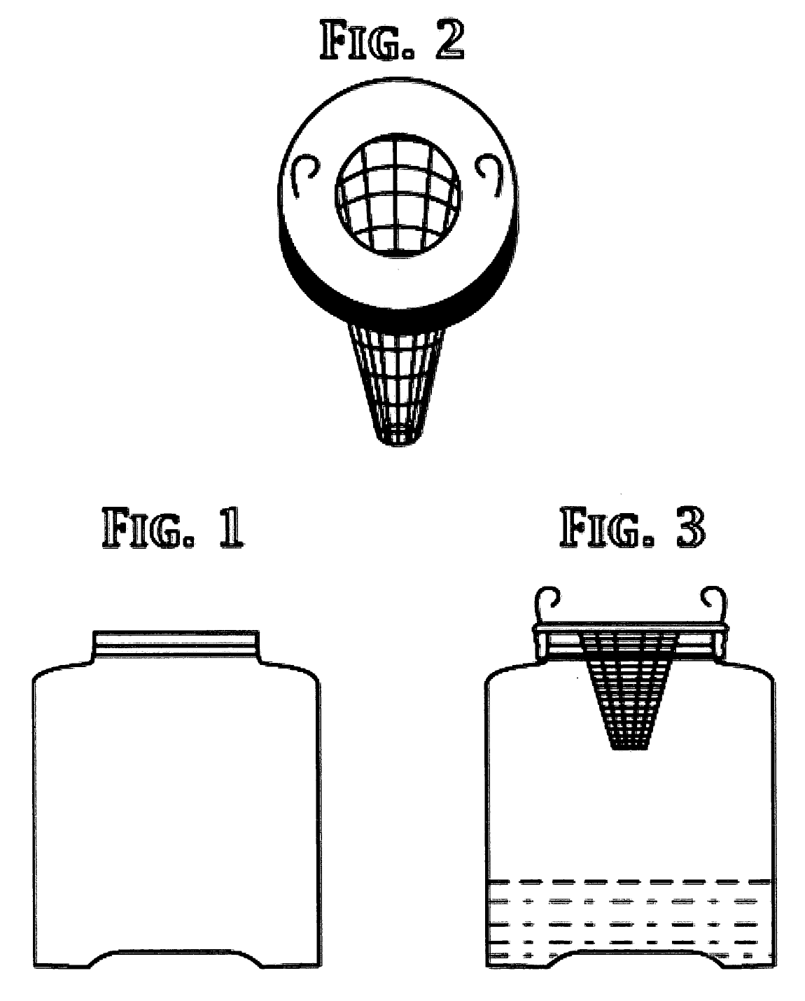

Referring to FIG. 1, my invention provides a transparent cylindrical container (#4) and (#5) is a convex opening at the top of said container, (#6) shows external threads as the top of said rim.

Line (#7-7) is an inwardly adjacent it's periphery to aid in supporting the device on a flat surface.

Referring to FIG. 2, (#8-8) are two ear-brackets used to suspend the lure.

Line (#9) is showing a landing perch of ¾″ wide by 12″ circumference.

Line (#10) is an entrance orifice at the top of the cap 2″ in diameter.

Line (#11) is a cap with internal threads adapted to operatively engage external threads (#6).

Referring back to FIG. 2. (#12) the orifice is made of a molded plastic type material or a ridged wire screen material.

(#14) is showing the total length of the conical to be 2½″ in length.

The bottom of the convex entryway porthole (#13) is ⅜″ in diameter to allow the passage of crawling insects, but will not allow the upwardly passage of a flying insect once inside the chamber.

(#15) is showing the chamber of said entrapment cylindrical contains a dried power mixture to be mixed with water for activation.

Referring to FIG. 3 (#18) is a view of the entrapment container fully assembled version thereof.

Referring back to FIG. 1, all exterior walls (#17) and all interior walls (#16) of said entrapment container are of solid smooth surface thereof.

Line (#19) the top part is rounded to provide a more curvilinear structure with more strength and rigidity.

What I claim is:

1. (canceled)

2. A transparent entrapment container to hold a substance attractant to entice said species of insects.

3. The two (2) pieces consisting of one container and one cap with internal threads adapted to operatively engage to the external threads of the entrapment container thereof.

4. The cap having a circular orifice at the top of said container and an environs landing perch on top of said container for insects to sit on before entering the orifice entrapment chamber below.

5-11. (canceled)
